(19) United States
(12) Patent Application Publication
(10) Pub. No.: US 2003/0022631 A1
(43) Pub. Date: Jan. 30, 2003

(54) Multi-mode bidirectional communications device including a diplexer having a switchable notch filter

(76) Inventors: Robert Andrew Rhodes, Carmel, IN (US); Kevin Paul McReynolds, Noblesville, IN (US); Michael Anthony Pugel, Noblesville, IN (US); Wesley John Boyd, Cedar Rapids, IA (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/043,700

(22) Filed: Jan. 11, 2002

Related U.S. Application Data
(60) Provisional application No. 60/305,193, filed on Jul. 13, 2001.
(60) Provisional application No. 60/327,529, filed on Oct. 2, 2001.

(51) Int. Cl. H04B 1/44

(52) U.S. Cl. 455/78; 455/84; 455/338; 455/340

(57) ABSTRACT

A multi-mode bidirectional communications device including a diplexer having a high-pass filter, a low-pass filter, and a notch filter selectively coupled to the low-pass filter. The notch-filter is selectively coupled to the low-pass filter in response to an indicium of a desired spectral region.

### CROSS REFERENCE TO RELATED APPLICATIONS

This patent application claims the benefit of U.S. Provisional Application serial No. 60/305,193, filed Jul. 13, 2001, which is incorporated herein by reference in its entirety, and U.S. Provisional Application serial No. 60/327,529, filed Oct. 2, 2001, which is also incorporated herein by reference in its entirety. This patent application is related to simultaneously filed U.S. Patent Application No. ______, filed ______ (Attorney Docket No. PU010147) entitled MULTI-MODE BIDIRECTIONAL COMMUNICATIONS DEVICE INCLUDING A DIPLEXER HAVING SWITCHABLE LOW PASS FILTERS; and U.S. Patent Application No. ______, filed ______ (Attorney Docket No. PU010223) entitled MULTI-MODE DOWNSTREAM SIGNAL PROCESSING IN A BI-DIRECTIONAL COMMUNICATIONS DEVICE, both of which are incorporated herein by reference in their entireties.

### FIELD OF INVENTION

The present invention relates to diplexers. More particularly, the invention relates to a single diplexer suitable for use in multiple standard systems such as both the North American and European DOCSIS standards.

### BACKGROUND OF INVENTION

Bi-directional communication devices, such as cable modems, have been designed to specifically operate under a single standard, such as the North American Data Over Cable Service Interface Specifications (DOCSIS) or the European DOCSIS standards. The European version of the North American DOCSIS standard was not available when DOCSIS was first proposed to European customers. Many European cable operators started deploying the North American DOCSIS standard. They now express the need to change to a European DOCSIS-compliant system.

There are three main differences between a European DOCSIS cable modem and a North American DOCSIS cable modem. First, a diplexer within the cable modem has a different cross over point in the European and North American systems, since the forward (downstream) and the return (upstream) data channel bandwidths on the coax cable are slightly different. This difference in diplexer crossover point is realized by different high pass filter and low pass filter cutoff frequencies between the European and North American systems. Second, the forward data channel is 8 MHz wide for European DOCSIS, while in the North American DOCSIS the forward data channel is 6 MHz wide. This requires a different surface acoustic wave (SAW) filter to maximize performance when additional channels are located next to the desired channel without any guard band. Third, the forward data channel for the European DOCSIS uses a different forward error correction (FEC) scheme than is used in the North American DOCSIS. Providing a single cable modem that could operate under both the North American and European standard systems would reduce the costs for the manufacturers, re-sellers, and renters by economy of scale.

### SUMMARY OF INVENTION

The disadvantages heretofore associated with the prior art, are overcome by a multi-mode bi-directional communications device including a diplexer having a high-pass filter, a low-pass filter, and a notch filter selectively coupled to the low-pass filter. The notch-filter is selectively coupled to the low-pass filter in response to an indicium of a desired spectral region.

A method of passing bi-directional communications signals of differing modes through a diplexer having a high-pass filter coupled between a first and a second signal port, a first low-pass filter selectively coupled to a notch filter, the low-pass filter coupled between the first and a third signal port, is also provided. In particular, the method includes receiving downstream signals at the first signal port and filtering the received downstream signals using the high-pass filter. The filtered downstream signals are then communicated to the second signal port. Furthermore, the method includes receiving upstream signals at the third signal port; selectively coupling the notch filter to the low-pass filter for filtering the received upstream signals in response to a desired communications mode, and sending the filtered signals to the first signal port.

### BRIEF DESCRIPTION OF THE DRAWINGS

The teachings of the present invention can be readily understood by considering the following detailed description in conjunction with the accompanying drawings, in which:

FIG. 1 depicts a block diagram of a data communications system having a multi-mode bidirectional communications device according to an embodiment of the present invention;

FIG. 2 depicts a block diagram of a diplexer suitable for use in the multi-mode bidirectional communications device of FIG. 1;

FIG. 3 depicts a graphical representation of a response curve for the diplexer FIG. 2;

FIG. 4 depicts an illustrative schematic diagram of a low-pass filter LPF having a notch filter NF selectively coupled thereon and suitable for use in the diplexer of FIG. 2; and

FIG. 5 depicts an illustrative schematic diagram of a high-pass filter HPF suitable for use in the diplexer of FIG. 2.

To facilitate understanding, identical reference numerals have been used, where possible, to designate identical elements that are common to the figures.

### DETAILED DESCRIPTION OF THE INVENTION

While the invention will be primarily described within the context of a cable modem in a data communications system, it will be appreciated by those skilled in the art that other multi-mode/standard, bidirectional communications devices, such as a satellite terminal, digital subscribe line (DSL), and the like may benefit from the present invention. According to one embodiment of the invention, a cable modem includes a single diplexer, which is used to facilitate the coupling of, for example, a computer device to a service provider via a cable transport network. In particular, the exemplary cable modem is utilized to provide downstream broadband data signals from the service provider to the computer device. Additionally, the exemplary cable modem is utilized to transfer upstream baseband data signals from the illustrative computer back to the service provider. More specifically, the exemplary cable modem is capable of selectively operating within the different downstream bandwidth constraints under both the North American Data Over Cable Service Interface Specifications (DOCSIS) and the European DOCSIS standards, which are incorporated by reference herein in their respective entireties. The cable modem is also capable of selectively passing through upstream data signals in compliance with both the European and North American DOCSIS standards.

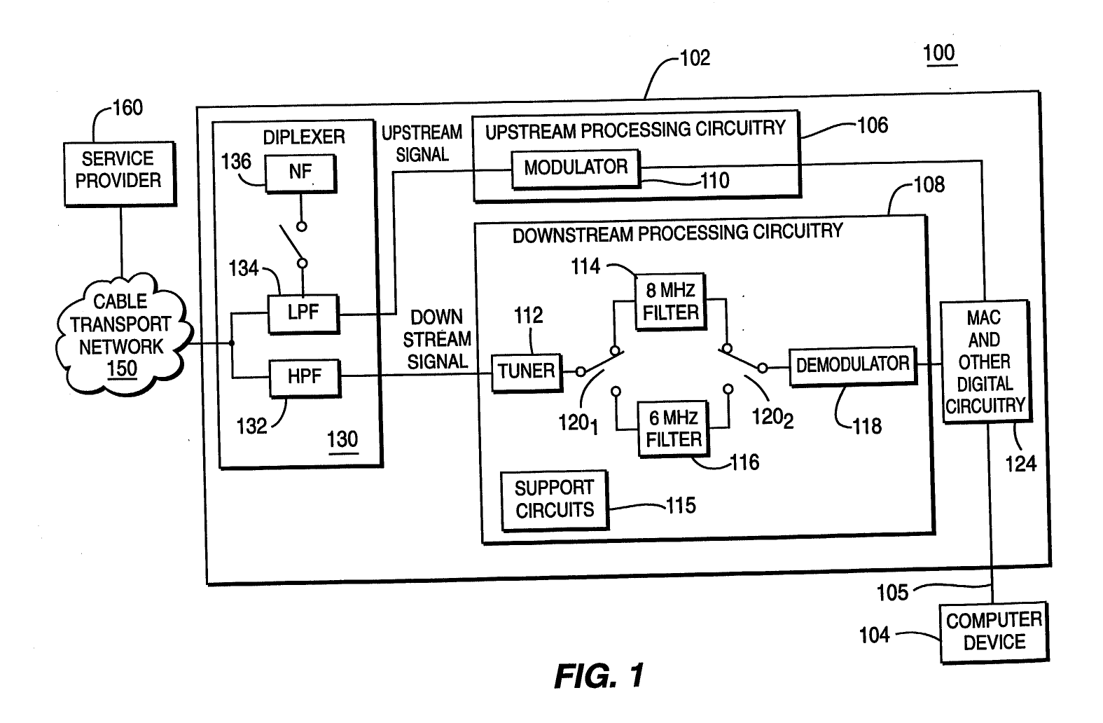

FIG. 1 depicts a block diagram of a data communications system 100 having a multi-mode bidirectional communications device 102 according to an embodiment of the present invention. The data communications system 100 comprises a service provider 160 that provides electronically transmitted, digital data to an end user having an input/output (I/O) device 104, such as a computer, hand-held device, laptop, or any other device capable or transmitting and/or receiving data. The service provider 160 is coupled to the multi-mode bi-directional communications device (e.g., cable modem) 102 via a cable transport network 150.

The service provider 160 may be any entity capable of providing low, medium and/or high-speed data transmission, multiple voice channels, video channels, and the like. In particular, data is transmitted via radio frequency (RF) carrier signals by the service provider 160 in formats such as the various satellite broadcast formats (e.g., Digital Broadcast Satellite (DBS)), cable transmission systems (e.g., high definition television (HDTV)), DVB-C (i.e., European digital cable standard), and the like.

The service provider 160 provides the data over the cable transport network 150. In one embodiment, the cable transport network 150 is a conventional bi-directional hybrid fiber-coax cable network, such as specified under the North American or European DOCSIS standards.

In operation, the service provider 160 modulates the downstream data signals with an RF carrier signal, and provides such signals via the cable transport network 150 to the cable modem 102, where the RF signals are received, tuned, and filtered to a predetermined intermediate frequency (IF) signal. The IF signal is then demodulated into one or more respective baseband signals, and otherwise processed into, illustratively, data packets. The data packets are further transmitted through, illustratively, cabling 105 (e.g., universal serial bus (USB), coaxial cable, and the like) to the computer device 104. Similarly, a user of the computer device 104 may send upstream data signals to the cable modem 102 via the cabling 105. The cable modem 102 receives upstream baseband data signals from the computer device 104, and then modulates and upconverts the data signals onto a RF carrier for transmission back to the service provider 160, via the cable transport network 150.

The cable modem 102 comprises diplexer 130, upstream processing circuitry 106, downstream processing circuitry 108, and a media access controller (MAC) 124. The diplexer 130 is coupled to the upstream and downstream processing circuitry 106 and 108. The diplexer 130 comprises a high-pass filter 132, and a low-pass filter 134 having a notch filter 136 which may be selectively coupled. The high-pass filter HPF 132 passes the downstream data signals to the downstream processing circuitry 108, while the low-pass filter LPF 134 receives return signals from the upstream processing circuitry 106. The notch filter NF 136 is selectively decoupled from the low-pass filter LPF 134 during operation under the European DOCSIS standard, while the notch filter 136 is coupled to the low-pass filter LPF 136 during operation under the North American DOCSIS standard. In particular, the high-pass filter 132 provides processed downstream RF signals to a tuner 112. Specifically, RF signals having a frequency greater than, illustratively, 88 MHz are passed through, while those frequencies below 88 MHz are filtered, as will be discussed in further detail below.

The downstream processing circuitry 108 comprises the tuner 112, a demodulator 118, which is selectively coupled to the tuner 112 through a first surface acoustic wave (SAW) filter 114 or through a second SAW filter 116, and other support circuitry 115, such as voltage regulators, amplifiers, and the like. The tuner 112 may illustratively be model type DIT9210, manufactured by Thomson Consumer Electronics, Inc. When operating under the European DOCSIS mode, the first SAW filter 114 provides an IF signal having an 8 MHz bandwidth to the demodulator 118, which operates within the requirements under the ITU J.83 Annex A standard. Alternately, when operating under the North American DOCSIS mode, the second SAW filter 116 provides an IF signal having a 6 MHz bandwidth to the demodulator 118, which then operates within the requirements under the ITU J.83 Annex B standard. Although, the illustrative embodiment depicts a single demodulator 118, one skilled in the art will recognize that separate modulators operating under the ITU J.83 Annex A and B standards may alternately be utilized.

The downstream processing circuitry 108 selectively tunes, demodulates, and otherwise “receives” at least one of a plurality of downstream data signals in response to a selection signal provided by, for example, the computer device 104. The diplexer 130 passes all downstream data signals above 88 MHz to the tuner 112 via the high-pass filter HPF 132. The tuner 112 downconverts the received downstream RF signals from the HPF 132 to a predetermined IF frequency signal. At least one switch selectively passes the IF frequency signal from the tuner 112 to the demodulator 118 via either the first SAW filter 114 or the second SAW filter 116. In one embodiment, the first and second SAW filters 114 and 116 are each coupled between the tuner 112 and demodulator 118, in parallel, via electronic switching devices 120, and 1202 (collectively “switches” 120), such as PIN diodes. That is, each illustrative PIN diode functions as an electronic switch for selectively coupling and decoupling each of the SAW filters 114 and 116 between the tuner 112 and the demodulator 118.

For example, a first PIN diode (not shown), which is coupled to the first SAW filter 114, is forward biased by a controller (not shown) to allow the first PIN diode to act as a short circuit as between the tuner 112 to the first SAW filter 114. As such, the first SAW filter 114 is coupled to the tuner 112. Additionally, a second PIN diode (not shown), which is coupled between the tuner 112 and the second SAW filter 116, is reversed biased by the controller to allow the PIN diode to act as an open circuit as between the tuner 112 to the second SAW filter 116. As such, the second SAW filter 116 is decoupled from the tuner 112. In this manner, only one of the two SAW filters is coupled to the tuner 112 at a time. Additionally, in a similar manner, a third and fourth PIN diode (not shown) may be utilized in conjunction with the controller to couple and decouple the first and second SAW filters 114 and 116 to the demodulator 118. One skilled in the art will recognize that other switching components (e.g., transistors, electromechanical switches, and the like) and circuits may be utilized to selectively couple and decouple the SAW filters 116 and 114 to the tuner 112 and demodulator 118. The downconverted IF signals are demodulated by the downstream processing circuitry 108 to provide one or more respective baseband signals, which are transferred to the computer device 104 for processing.

When operating under the North American DOCSIS standard, the exemplary second SAW filter 116 provides a 44 MHz centered IF signal having a 6 MHz bandwidth to the demodulator 118, where the demodulator 118 extracts the baseband signal(s) therein. Similarly, when operating under the European DOCSIS standard, the exemplary first SAW filter 114 provides a 36.125 MHz centered IF signal having an 8 MHz bandwidth to the demodulator 118, where the demodulator 118 extracts the baseband signal(s) therein. In any case, the baseband signals are sent to the media access controller (MAC) 124 for subsequent transport to the computer device.

The baseband signals are illustratively formed into packets (e.g., MPEG elementary stream packets). The media access controller and other digital circuitry 124 may further process the packetized data (e.g., attach or encapsulate in appropriate transport packets) and then distribute the processed, packetized data to the computer devices 104.

The upstream processing circuitry 106 comprises a modulator 110 and other support circuits such as amplifiers, filters, voltage regulators, and the like (not shown). The modulator 110 modulates upstream signals from the computer device 104 for subsequent transmission to the service provider 160. In particular, a user sends data, data requests, or some other user request to the service provider. The user request is up converted and modulated to an upstream RF signal.

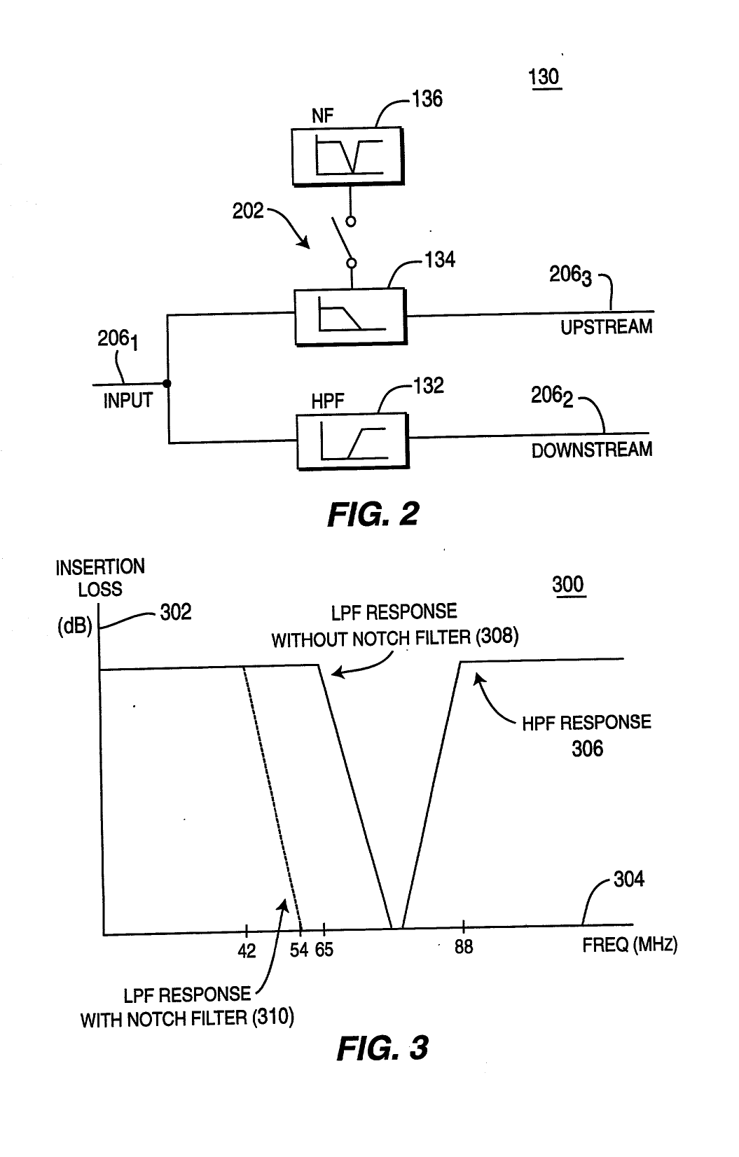

FIG. 2 depicts a block diagram of a diplexer 130 according to the present invention. A high-pass filter 132 is coupled between a first signal port 206₁ and a second signal port 206₂. The high-pass filter 132 provides an RF frequency path to the downstream processing circuitry 108 from the cable transport network 150, as discussed above. Additionally, a low-pass filter 134 is coupled between the first signal port 206, and a third signal port 206₃. The low-pass filter LPF 134 has a notch filter NF 136 selectively coupled thereon via switch 202. The low-pass filter LPF 134, either singularly or in combination with the notch filter NF 136, provides an RF frequency path from the upstream processing circuitry 106 to the cable transport network 150. The modulated upstream RF signal is filtered by the low-pass filter 134 (and, selectively, the notch filter 136, depending on the DOCSIS standard the cable modem is operating) for transmission to the service provider 160 via the cable transport network 150. In the instant embodiment of the present invention, it is noted that the low-pass filter LPF 134 is utilized without coupling to the notch filter 136 for operation under the European DOCSIS standard such that signals between 5-42 MHz may be passed. Alternately, the low-pass filter LPF 134 is coupled to the notch filter 136 for operation under the North American DOCSIS standard to pass signals between 5-65 MHz.

FIG. 3 depicts a graphical representation of a response curve 300 for the diplexer of FIG. 2, and should be viewed along with FIG. 2. The response curve 300 comprises an ordinate 302 and an abscissa 304. The ordinate 302 represents insertion loss (measured in decibels (dB)), and the abscissa 304 represents frequency (measured in megahertz (MHz)).

Referring to FIGS. 2 and 3 together, it can be seen that the high-pass filter HPF 132 passes RF signals having a frequency greater than 88 MHz. Under the North American DOCSIS standard, the downstream data signals are transmitted at a frequency greater than 88 MHz, while under the European DOCSIS standard the downstream data signals are transmitted at a frequency greater than 110 MHz. In this case, only a single high-pass filter HPF 132 is utilized in the diplexer 130. Specifically, the HPF 132 passes RF data signals above a frequency of 88 MHz. Since all downstream RF signals are above 88 Mhz, the single HPF 132 is suitable for passing through such downstream RF data signals for further processing in the cable modem 102 under both the North American and European DOCSIS standards. The HPF response curve 306 in FIG. 3 depicts a low level of insertion loss 302 for frequencies greater than 88 MHz.

Under the North American DOCSIS standard, the upstream data signals are transmitted in a frequency range between 5 Mhz and 42 MHz, while under the European DOCSIS standard the upstream data signals are transmitted in a frequency range between 5 MHz and 65 MHz. In this case, the low-pass filter LPF 134 and selectively coupled notch filter NF 136 are provided to illustratively pass through data signals up to 42 MHz and 65 MHz respectively. In particular, the low-pass filter LPF 134 when coupled to the notch filter NF 136 passes through the upstream data signals, illustratively, having a frequency between 5 Mhz and 42 MHz as required under the North American DOCSIS standard. The LPF response curve 310 in FIG. 3 depicts a low level of insertion loss 302 for frequencies less than 42 MHz when operating under the North American DOCSIS standard.

Similarly, the low-pass filter 134 passes through the upstream data signals, illustratively, having a frequency between 5 MHz and 65 MHz as required under the European DOCSIS standard. In this instance, the notch filter NF 136 is selectively decoupled from the low-pass filter LPF 134. The LPF response curve 308 in FIG. 3 depicts a low level of insertion loss 302 for frequencies less than 65 MHz when operating under the European DOCSIS standard.

Referring to FIG. 2, switch 202 is a schematic representation for selectively coupling and decoupling the notch filter NF 136 to the low-pass filter 134, thereby permitting the diplexer 130 to be set for operation under either of the DOCSIS standards. In one embodiment, the switch 202 may be an electromechanical relay. Preferably, the switch 202 is a digitally operable switch, such as a PIN diode, transistor, and the like, controlled by a controller, such as a microprocessor, as discussed in further detail below. In an instance where the switch 202 selectively decouples the notch filter NF 136 from the LPF low-pass filter 134, the diplexer 130 passes through frequencies less than 65 MHz along the cable transport network 150, as set forth under the European DOCSIS standard. Similarly, in an instance where the switch 202 selectively couples the notch filter NF 136 to the LPF low-pass filter 134, the diplexer 130 passes through frequencies less than 42 MHz along the cable transport network 150, as set forth under the North American DOCSIS standard.

It is noted that two separate de facto filters (e.g., the low-pass filter LPF 134, and the low-pass filter LPF 134 in conjunction with the notch filter NF 136) are utilized for passing the upstream RF signal, as compared to only a single high-pass filter HPF 132 being utilized to pass downstream RF signals. It is further noted that a single low-pass filter may not be used for both the North American and European cable modems. In particular, there are stringent limits on the energy that can be transmitted upstream in the frequency band above the upstream data band. For example, the low-pass filter for the North American system must have low attenuation for frequencies between 5 and 42 MHz and high attenuation for frequencies above 54 MHz (see response curve 310). The low-pass filter for the European system must have low attenuation for frequencies between 5 and 65 MHz and high attenuation for frequencies above 88 MHz (see response curve 308). The requirements between 54 and 65 MHz are in direct confict, therefore different responses, and hence, different low-pass filters are required under each DOCSIS standard.

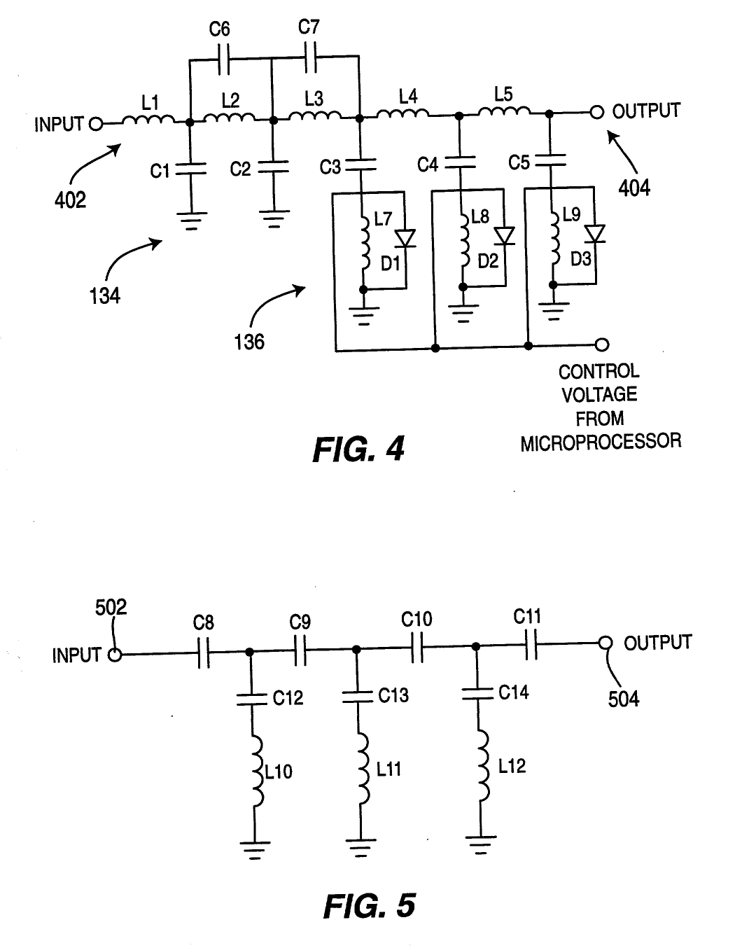

FIGS. 4 and 5 depict illustrative schematic representations of the components in the diplexer 130. In general, the low-pass filter LPF 134 comprises a plurality of inductors connected in series between the first and third signal ports 206₁ and 206₃ each of the inductors being coupled to ground via a respective capacitor forming thereby a plurality of single pole filter elements, a portion of the inductors being bypassed by respective capacitors. Furthermore, the notch filter NF 136 comprises a second plurality of inductors, where each inductor is respectively coupled between a portion of the capacitors of the single pole filter elements of the low-pass filter LPF 134 and ground.

In particular and referring to FIG. 4, the low-pass filter LPF 134 comprises inductors L1 through L5 coupled to capacitors C1 through C7 for passing frequencies less than 65 MHz. In particular, the inductors L1 through L5 are coupled end-to-end in series, where inductor L1 is coupled to an input 402 and L5 is coupled to an output 404 of the LPF filter 134. Capacitor C1 is coupled from ground to the node between L1 and L2. Capacitor C2 is coupled from ground to the node between L2 and L3. Capacitor C3 is coupled from the node between L3 and L4 to inductor L7, which is then coupled to ground. Capacitor C4 is coupled from the node between L4 and L5 to inductor L8, which is then coupled to ground. Capacitor C5 is coupled from the node between L5 and the output 404 to inductor L9, which is then coupled to ground. Capacitor C6 is coupled in parallel to inductor L2 and capacitor C7 is coupled in parallel to inductor L3. It is noted that the notch filter NF 136 is formed by inductors L7 through L9, which are serially coupled between capacitors C3 through C5, respectively, and ground.

In one embodiment, a mechanism for coupling and decoupling the notch filter NF 136 to the low-pass filter 34 is illustratively provided by a plurality of PIN switch diodes coupled to a controller. Alternately, other switching mechanisms may be utilized, such as transistors, electromechanical devices, and the like. Referring to FIG. 4, PIN switch diode D₁ is coupled in parallel to inductor L7 between capacitor C3 and ground. PIN switch diode D₂ is coupled in parallel to inductor L8 between capacitor C4 and ground. PIN switch diode D₃ is coupled in parallel to inductor L9 between capacitor C5 and ground. Furthermore, the PIN diodes D₁ through D₃ have their respective cathodes tied to ground and their anodes coupled to the controller (e.g., a microprocessor in the MAC 124).

In operation, the microprocessor selectively provides a voltage control signal to the anodes of the pin diodes D₁ through D₃. In particular, when the pin diodes D₁ through D₃ are forward biased (i.e., act as a short circuit), the current discharged from capacitors C3 through C5 bypasses the notch filter 136, (which comprises inductors L7 through L9) and goes directly to ground. Such is the case when the diplexer 130 is operating under the European DOCSIS standard. Alternately, when the PIN diodes D₁ through D₃ are reversed biased (i.e., act as an open circuit), the current discharged from capacitors C3 through C5 passes through the notch filter 136, (which comprises inductors L7 through L9) prior to being coupled to ground. Such is the case when the diplexer 130 is operating under the North American DOCSIS standard.

Table 1 depicts one embodiment of the values of the inductors and capacitors L1-L5 and C1-C7 of the low-pass filter LPF 134 without the components of the notch filter NF 136 selectively coupled thereto. Additionally, Table 1 also depicts one embodiment of the values of the three inductors L7-L9, which primarily form the notch filter NF 136 portion of the low-pass filter. Regarding Table 1, inductor and capacitance values are illustratively measured, respectively, in nano Henry and pico farads.

TABLE 1

| LPF (FIG. 4) | | | | NF (FIG. 4) | | HPF (FIG. 5) | | | |
|---|---|---|---|---|---|---|---|---|---|
| L | (nH) | C | (pF) | L | (nH) | L | (nH) | C | (pF) |
| L1 | 250 | C1 | 38 | L7 | 160 | L10 | 210 | C8 | 15 |
| L2 | 160 | C2 | 33 | L8 | 250 | L11 | 310 | C9 | 150 |
| L3 | 220 | C3 | 36 | L9 | 200 | L12 | 160 | C10 | 13 |
| L4 | 330 | C4 | 36 | | | | | C11 | 12 |
| L5 | 300 | C5 | 39 | | | | | C12 | 72 |
| | | C6 | 26 | | | | | C13 | 69 |
| | | C7 | 10 | | | | | C14 | 93 |

In general, the high-pass filter HPF 132 comprises a plurality of capacitors connected in series between the first and the second signal ports 206₁ and 206₂, each of the capacitors being coupled to ground via serially coupled circuit elements forming thereby a plurality of single pole filter elements, each of the serially coupled circuit elements comprising a capacitor and inductor. In particular and referring to FIG. 5, the high-pass filter HPF 132 comprises inductors L10 through L12 coupled to capacitors C8 through C14 for passing frequencies greater than 88 MHz. In particular, capacitors C8 through C11 are coupled end-to-end in series, where capacitor C8 is coupled to an input 502 and C11 is coupled to an output 504 of the HPF filter 132. Capacitor C12 is coupled to the node between capacitors C8 and C9 and serially coupled to inductor L10, which is coupled to ground. Capacitor C13 is coupled to the node between capacitors C9 and C10 and serially coupled to inductor L11, which is coupled to ground. Capacitor C14 is coupled to the node between capacitors C10 and C11 and serially coupled to inductor L12, which is coupled to ground. Table 1 above also depicts a preferred embodiment of the values of the inductors and capacitors L10-L12 and C8-C14 of the high-pass filter HPF 132.

FIGS. 4 and 5 depict one of many possible embodiments to implement a multi-mode bi-directional communications device (e.g., cable modem) 102, which can be operated under multiple standards, for example, between the European and North American DOCSIS standards. The diplexer 130 utilizes a single high-pass filter HPF 132 to adjust the cutoff frequency of the diplexer's forward (i.e., downstream) channel, and switches between two de facto filters low-pass and notch filters LPF and NF 134 and 136 to adjust the cutoff frequency of the diplexer's return (i.e., upstream) channel. It should be apparent to those skilled in the art and informed by the present disclosure that a novel diplexer for passing RF signals for multi standard data communication systems operating, illustratively, under both the North American and European DOCSIS standards has been provided. It should also be noted that FIG. 1 depicts the upstream processing circuitry 106, downstream circuitry 108, and media access controller 124 as separate components. However, one skilled in the art will understand that these illustratively distinct components may also be fabricated, for example, as a single integrated circuit (e.g., ASIC) as well.

Although various embodiments that incorporate the teachings of the present invention have been shown and described in detail herein, those skilled in the art can readily devise many other varied embodiments that still incorporate these teachings.

What is claimed is:

1. A multi-mode bidirectional communications device, comprising:
a diplexer having a high-pass filter, a low-pass filter, and
a notch filter selectively coupled to the low-pass filter in response to indicium of a desired spectral region.

2. The device of claim 1, further comprising upstream processing circuitry and downstream processing circuitry coupled to said diplexer.

3. The device of claim 2, wherein the downstream processing circuitry comprises:
a tuner;
a demodulator;
a first SAW filter selectively coupled between said tuner and said demodulator; and
a second SAW filter selectively coupled between said tuner and said demodulator.

4. The device of claim 3, wherein the first SAW filter has a bandwidth of 6 MHz and the second SAW filter has a bandwidth of 8 MHz.

5. The device of claim 3, further comprising at least one selector for selectively coupling the first SAW filter and the second SAW filter between the tuner and the demodulator.

6. The device of claim 3, wherein said high-pass filter is coupled to said tuner.

7. The device of claim 1, wherein said high-pass filter passes signals greater than 88 MHz.

8. The device of claim 2, wherein said upstream processing circuitry is selectively coupled to one of said low-pass filter and said low-pass filter in conjunction with said notch filter.

9. The device of claim 1, wherein the low-pass filter nominally passes signals less than 65 MHz, and passes signals less than 42 MHz when the notch filter is coupled thereto.

10. The device of claim 1, wherein at least one switch is used to select the notch filter.

11. The device of claim 10, wherein the at least one switch is selected from the group consisting of a transistor, a PIN diode, a diode, and an electromechanical switch.

12. The device of claim 1, wherein said device is selected from the group comprising a cable modem and a satellite terminal.

13. The device of claim 1, wherein said device supports multiple standards selected from the group consisting of the North American Data Over Cable Service Interface Specifications (DOCSIS) or the European DOCSIS standards.

14. A diplexer, comprising:
a high-pass filter coupled between a first signal port and a second signal port;
a low-pass filter coupled between a first signal port and a third signal port; and
a notch filter, selectively coupled to the low-pass filter in response to indicium of a desired spectral region.

15. The diplexer of claim 14, wherein said low-pass filter comprises:
a first plurality of inductors connected in series between said first and third signal ports, each of said inductors being coupled to ground via a respective capacitor forming thereby a plurality of single pole filter elements, a portion of said inductors being bypassed by respective capacitors; and
said notch filter comprises:
a second plurality of inductors, where each inductor is respectively coupled between a portion of the capacitors of the single pole filter elements of the low-pass filter and ground.

16. The diplexer of claim 14 wherein said high-pass filter comprises:
a plurality of capacitors connected in series between said first and second signal ports, each of said capacitors being coupled to ground via serially coupled circuit elements forming thereby a plurality of single pole filter elements, each of said serially coupled circuit elements comprising a capacitor and inductor.

17. The diplexer of claim 14 further comprising a selector for selectively coupling the notch filter to the low-pass filter.

18. The diplexer of claim 14, wherein the selector comprises at least one switch selected from the group consisting of PIN diodes, transistors, and electromechanical switches.

19. The diplexer of claim 15 wherein the selector comprises:
a plurality of PIN diodes respectively coupled in parallel with said second plurality of inductors, wherein said PIN diodes are adapted for connection to a control signal for selectively biasing the PIN diodes to couple and decouple the notch filter to the low-pass filter.

20. A method of passing bi-directional communications signals of differing modes through a diplexer having a high-pass filter coupled between a first and a second signal port, a first low-pass filter selectively coupled to a notch filter, said low-pass filter coupled between the first and a third signal port, comprising:
receiving downstream signals at the first signal port;
filtering the received downstream signals using said high-pass filter;
communicating filtered downstream signals to the second signal port;
receiving upstream signals at the third signal port;
selectively coupling said notch filter to the low-pass filter for filtering the received upstream signals in response to a desired communications mode; and
sending the filtered signals to the first signal port.
